(19) United States
(12) Patent Application Publication
(10) Pub. No.: US 2026/0091770 A1
(43) Pub. Date: Apr. 2, 2026

(54) ROTATIONAL ANGLE DETECTION SYSTEM FOR DETECTING A ROTATIONAL ANGLE OF A ROTARY BRAKE DRIVE FOR A RAIL VEHICLE

(71) Applicant: KNORR-BREMSE SYSTEME FÜR SCHIENENFAHRZEUGE GMBH, Munich (DE)

(72) Inventors: Alexander JUNG, Gauting (DE); Ulf FRIESEN, Neubiberg (DE); Cheng LIU, Munich (DE); Richard GRUNDWÜRMER, Ingolstadt (DE)

(21) Appl. No.: 19/110,754

(22) PCT Filed: Aug. 25, 2023
(86) PCT No.: PCT/EP2023/073363

§ 371 Date: Mar. 11, 2025

(30) Foreign Application Priority Data
Sep. 12, 2022 (DE) 10 2022 123 084.8

(51) Int. Cl. B60T 17/22; B60T 13/74; B61H 13/34; F16D 66/00; F16D 121/24; G01D 5/244

(52) U.S. Cl. CPC B60T 17/228; B60T 13/741; B61H 13/34; F16D 66/00; G01D 5/244; B60T 2270/402; B60T 2270/413; F16D 2066/003; F16D 2066/006; F16D 2121/24; G01D 2205/24

(57) ABSTRACT

A rotational angle detection system detects a rotational angle of a rotary brake drive for a rail vehicle and includes at least one sensor unit for detecting a rotational angle operatively connected to the rotary brake drive, and at least one main electronics path for transmitting control signals and/or sensor signals, wherein the at least one main electronics path can be operatively connected to the at least one sensor unit, wherein the at least one main electronics path includes at least one signal transmitter subdividing the main electronics path into a main electronics path section close to the sensor unit, viewed from the signal transmitter, and a main electronics path section remote from the sensor unit, viewed from the signal transmitter, and the at least one signal transmitter designed to electrically isolate the at least one sensor unit from the main electronics path section remote from the sensor unit.

### CROSS REFERENCE AND PRIORITY CLAIM

This patent application is a U.S. National Phase of International Patent Application No. PCT/EP2023/073363 filed Aug. 25, 2023, which claims priority to German Patent Application No. 10 2022 123 084.8, the disclosure of which being incorporated herein by reference in their entireties.

### FIELD

Disclosed embodiments relate to a rotational angle detection system for a rotational angle detection of a rotary brake drive for a rail vehicle and a braking system for a rail vehicle and a rail vehicle with such a rotational angle detection system.

### BACKGROUND

In rail vehicles, for example, electromechanical brake actuators, such as brake cylinders, are designed in such a way that electrical energy is converted into mechanical energy with the help of an electric motor. When the brake actuator or brake cylinder is actuated, rotary movement of the rotor in the electric motor takes place. This rotary movement is further transmitted to a spindle nut permanently installed in a hollow shaft. Since the rotating spindle nut is permanently installed in the axial direction, this results in a feed movement of the spindle. In a further step, an eccentric shaft lever is used to rotate an eccentric shaft and operate the caliper levers. Accordingly, the brake pads attached to holders can be pressed against a rotating brake disc by the caliper levers to generate a braking force. To release the brake, the electric motor rotates in the opposite direction and thus resets the screw drive.

For the actuation of the electric motor, for example a permanent magnetically excited synchronous machine or PMSM for short, a rotational angle encoder is used to detect the rotor position. In addition to the rotational angle encoder, the brake actuator housing can also have other sensors as well as electrical and mechatronic components, such as limit switches, force measurement rings or engine braking devices. Due to the possible installation in a bogie, there are increased requirements for high voltage and insulation strength, including HV/ISO strength. This relates in particular to an increased system voltage of 110 V instead of 48 V, which can be used for a brake actuator. For example, in a type test, an HV/ICO resistance of 500 VAC at 50 Hz or 750 VDC at 48 V must be achieved for a duration of 60 seconds, while at 110 V this must be 1000 VAC at 50 Hz or 1500 VDC. In addition, in this example, for a piece test for a duration of 10 seconds, an HV/ISO strength of 500 VAC at 50 Hz or 750 VDC at 48 V and at 110 V of 1000 VAC at 50 Hz or 1500 VDC may be required. The requirements are applicable here as examples to configurations in which no prior potential isolation takes place and, for example, 110 V is transmitted directly from the rail vehicle cables. Corresponding tests are carried out between the housing of the respective components and the electronics or the live components, such as windings, cable outlets and the like.

In principle, a higher voltage/insulation strength can be achieved by increasing the insulation to the electrically conductive components and contact surfaces. This can be achieved on the one hand by increasing internal insulation distances from live parts to corresponding housing parts of the sensors, or on the other hand by the additional and increased use of non-conductive materials, such as plastic. For example, in the case of electrical cables, the corresponding wire insulation can be reinforced, or in the case of electronic boards, the insulation distances can be increased and more suitable components can be selected for the higher voltage classes, such as ESD capacitors for 1 kV and more.

Specifically, many standard sensors and components available on the market do not have the required high HV/ISO strength, especially with regard to the increased requirements for a system voltage of 110 V. To meet this increased requirement, manufacturers must make customer-specific adjustments, such as better insulated winding wires, housings with plastic sheathing and/or replacement of electronic components. As a rule, such interventions are associated with higher effort as well as rising development costs, higher unit prices and poorer availability.

Ultimately, the measures listed to increase HV ISO strength mean that necessary modifications must be made to the sensor that no longer correspond to the standard product. However, in addition to meeting the increased requirements for HV ISO strength, this also entails the aforementioned and other disadvantages. From a technical point of view, corresponding modifications can also result in shorter durability or service life, for example in plastic housings, and in a larger installation space requirement, for example due to thicker wire diameters. Such modifications can also limit the scope of application, as there may be restrictions on possible vibrations or shock loads, limitations in the temperature profile, environmental pollution and/or limited installation situations.

### SUMMARY

In view of the foregoing, disclosed embodiments provide an improved rotational angle detection system compared to the prior art, in particular with regard to increased voltage/insulation strength with the simplest possible and thus cost-effective configuration.

Disclosed embodiments provide a rotational angle detection system for a rotational angle detection of a rotary brake drive for a rail vehicle has at least one sensor unit for detecting a rotational angle, which can be operatively connected to the rotary brake drive, as well as at least one main electronic path for the transmission of control signals and/or sensor signals, wherein the at least one main electronic path can be operatively connected to the at least one sensor unit, wherein the at least one main electronic path has at least one signal transmitter that divides the main electronic path into a section of the main electronic path which is close to the signal transformer when viewed from the sensor unit and a section of the main electronic path which is remote from the signal transmitter when viewed from the sensor unit, and wherein the at least one signal transmitter is configured to galvanically isolate the at least one sensor unit from the section of the main electronic path which is remote from the sensor unit.

### BRIEF DESCRIPTION OF THE FIGURES

Disclosed embodiments are described below with the help of the attached drawings.

In the figures in detail,

FIG. 1 shows a schematic representation of a rotational angle detection system for a rail vehicle according to an exemplary first embodiment;

FIG. 2 shows a schematic representation of a rotational angle detection system for a rail vehicle according to an exemplary second embodiment;

FIG. 3 shows a schematic representation of a rotational angle detection system for a rail vehicle according to an exemplary third embodiment; and

FIG. 4 shows a schematic representation of a rotational angle detection system for a rail vehicle according to an exemplary fourth embodiment.

### DETAILED DESCRIPTION

Disclosed embodiments are concerned with realizing the HV/ISO strength in another region of the system chain. Accordingly, for example, the sensor unit or a corresponding sensor of the sensor unit does not have to be modified and can therefore continue to be implemented as a standard product, but the sensor unit or the corresponding sensor is galvanically isolated in a main electronic path as a signal and/or control path for the sensor unit, for example in the form of electrical supply cables. A component can be used as a signal transmitter intended for galvanic isolation that can provide HV/ISO strength to meet the requirement in a much simpler and thus more cost-effective way. This makes it easier to suitably galvanically isolate the other electronics in the overall system in accordance with the higher requirements.

The operative connectability or connectivity of the main electronic path concerns both a direct and indirect connection of the individual paths for signal transmission. In addition, the operative connection can also refer to an actual activation of the main electronic path or of components in the main electronic path, such as a signal conditioning unit. In other words, the at least one main electronic path can, for example, be constantly physically connected to the sensor unit, wherein, strictly speaking, an operative connection only takes place when the corresponding signal conditioning unit is activated.

The operative connection of the sensor unit to the rotary brake drive can equally include both a direct connection and an indirect connection. The connection can be made mechanically and/or with signal technology. The sensor unit can thus generate at least one signal representing a rotational angle both in direct contact as well as via optical, acoustic and/or electrical or electromagnetic signals in interaction with the rotary brake drive, which can be forwarded via the main electronic path to a respective signal processing unit or similar.

According to one design, the rotational angle detection system also has at least one safety electronic path for the transmission of control signals and/or sensor signals, wherein the at least one safety electronic path can be operatively connected to the at least one sensor unit, wherein the at least one safety electronic path has at least one signal transmitter that divides the safety electronic path into a section of the safety electronic path which is close to the signal transmitter when viewed from the sensor unit and a section of the safety electronic path which is remote from the signal transmitter when viewed from the sensor unit, and wherein the at least one signal transmitter is configured to galvanically isolate the at least one sensor unit from the section of the safety electronic path which is remote from the sensor unit.

The main electronic path and the safety electronic path are separate individual paths that are connected in parallel or run fundamentally separately. The main electronic path can be understood as the electronic path that is operatively connected to the sensor unit in trouble-free operation in order to be able to conduct sensor signals or other signals, such as control signals or the like, unidirectionally or bidirectionally. Accordingly, the safety electronic path can only be or become operatively connected to the sensor unit if a fault prevents or otherwise interferes with transmission via the main electronic path. Alternatively, the main electronic path and the safety electronic path can be operatively connected to the sensor unit at the same time, at least temporarily, so that a plausibility check of the transmitted signals is possible or, even if the main electronic path fails, the signals can be transmitted without delay via the safety electronic path. The operative connectability of the safety electronic path relates to both a direct and indirect connection of the individual paths for signal transmission, comparable to the main electronic path. In addition, the operative connection can also refer to an actual activation of the individual paths or the respective signal conditioning unit.

The configuration of the rotational angle detection system with a main electronic path and a safety electronic path can refer to a redundant design of the rotational angle detection system in this respect. The basic idea is that instead of two or more complete sensor paths, which have both the sensor unit itself and, for example, a signal conditioning unit, such as suitable signal processing electronics, a sensor unit with two or more signal processing units is used to achieve redundancy, wherein at least one of the signal processing units is associated with the main electronic path and at least one of the signal processing units is associated with a safety electronic path.

By designing the rotational angle detection system with a sensor unit with redundant individual paths, a reduction in the required installation space can be supported in particular by the fact that the respective signal processing units can be realized by small microelectronic and/or highly integrated components, which have a comparatively small space requirement even if the individual paths are implemented redundantly. The redundant implementation of the individual paths, i.e., the safety electronic path with regard to the main electronic path or the respective signal processing units, can refer to an identical function implementation or to a redundancy of predetermined, in particular safety-relevant functions.

However, the safety electronic path can also be designed as an independent electronic function path that performs further functions independently of or in addition to a redundancy function and/or provides for different signal transmission. In such a configuration, the safety electronic path is not strictly speaking a single security path, but rather a second electronic function path.

The configuration with at least one main electronic path and at least one safety electronic path is in itself also a configuration principle of a rotational angle detection system that can be used independently of the increase in HC/ISO strength, which has synergies but can also be used independently.

Thus, in independent consideration, the disclosure results in a rotational angle detection system for a rotational angle detection of a rotary brake drive for a rail vehicle, at least one sensor unit for detecting a rotational angle which can be operatively connected to the rotary brake drive, as well as having at least one main electronic path and at least one safety electronic path per sensor unit, wherein the at least one main electronic path and the at least one electronic security path can be operatively connected to the at least one sensor unit as separate paths, wherein the at least one main electronic path and the at least one safety electronic path each have at least one signal conditioning unit.

According to a design of the disclosure of the redundant rotational angle detection system, the sensor unit has a higher reliability than the at least one main electronic path and/or the at least one safety electronic path. In particular, the sensor unit has inalienable properties in terms of higher reliability.

According to this, the sensor unit, such as a single sensor element, is designed to be simple, reliable and fail-safe in order to achieve the highest possible reliability. This can be done, for example, by suitable measures, such as a durable mechanical design, reinforced insulation, larger cable cross-sections and/or the use of ageing-resistant materials. In particular, the sensor unit is designed in such a way that its properties “cannot be lost” over a defined period of use or even over its entire service life. In this context, the term “properties that cannot be lost” refers to a failure that is not to be expected. Since the signal conditioning units or the connected individual paths are redundant, at least in predefined functionalities, functionalities with lower reliability can be moved to these individual paths. Especially with regard to a signal conditioning unit with corresponding components in usually comparatively higher complexity, which have a higher probability of failure, the higher probability of failure can be at least partially compensated for by the redundancy.

According to an embodiment of the disclosure of the redundant rotational angle detection system, the signal conditioning unit of the at least one main electronic path and/or at least one safety electronic path has at least one signal converter.

For example, by means of the at least one signal converter sensor signals transmitted by the sensor unit can be converted into signals that can be processed by other signal processing components. For example, the signal converter can be an A/D converter that converts an analog signal from the sensor unit into a digital format.

According to an embodiment of the disclosure of the redundant rotational angle detection system, the signal conditioning unit of the at least one main electronic path and/or the at least one safety electronic path has at least one signal processing unit.

For example, the signal processing unit further processes the signal of the sensor unit, which has optionally been previously converted by the signal converter. Further processing can include a calculation into a different quantity taking into account further signal inputs and/or a different form of signal processing to determine a rotational angle of the rotary brake drive based on the signal from the sensor unit.

According to an embodiment of the disclosure of the redundant rotational angle detection system, the signal conditioning unit of the at least one main electronic path and/or at least one safety electronic path has at least one signal output unit.

The signal output unit outputs the rotational angle of the rotary brake drive determined based on the signal of the sensor unit. The signal output unit can be a separate unit of the signal processing unit or it can also be integrated into the above signal processing unit. Conversely, the signal output unit can also include signal processing functions.

According to an embodiment of the disclosure of the redundant rotational angle detection system, the at least one main electronic path and/or the at least one safety electronic path have or has at least one signal switch via which the at least one signal conditioning unit can be operatively connected to the at least one sensor unit.

By means of such a signal switch, the at least one main electronic path and/or the at least one safety electronic path can be optionally connected to the sensor unit and disconnected again. If a fault in the at least one main electronic path and/or at least one safety electronic path could be transferred to the sensor unit or could otherwise have a negative effect on the sensor unit, this is prevented by disconnecting the faulty individual path. In addition, the signal switch can also be used to make the intended connection to the sensor unit. For example, initially only a single path can be connected to the sensor unit, wherein in the event of a corresponding failure of this single path or for other reasons, the other individual path is connected or switched to via the signal switch. The term connection refers to the connection of both individual paths, while switching to disconnects the previous single path.

According to an embodiment of the disclosure of the redundant rotational angle detection system, the at least one main electronic path and/or the at least one safety electronic path have or has at least one power supply unit that can be operatively connected to the at least one sensor unit.

The sensor unit does not necessarily need its own power supply, but can be supplied with energy via the at least one main electronic path and/or the at least one safety electronic path. If both the at least one main electronic path and/or the at least one safety electronic path have at least one power supply unit or a corresponding connection to a power supply unit, the reliability can be further increased.

According to an embodiment of the disclosure of the redundant rotational angle detection system, the at least one main electronic path and/or the at least one safety electronic path have or has at least one power supply switch, by means of which the at least one power supply unit can be operatively connected to the at least one sensor unit.

Comparable to the signal switch, here too an intended connection and disconnection of the respective energy supply unit can also be carried out.

The various embodiments of the disclosure of the redundant rotational angle detection system can be applied on their own or in combination with the rotational angle detection system of the of the disclosed embodiments with respect to a configuration with a safety electronic path.

According to one design, the at least one sensor unit is arranged in a sensor unit housing, and the at least one signal transmitter of the main electronic path and/or the safety electronic path forms the signal input and/or signal output of the main electronic path and/or the safety electronic path into and/or out of the sensor unit housing.

The at least one signal transmitter thus forms an interface for the sensor unit, so that the signal transmitter can also be easily retrofitted. In particular, the signal transmitter can be arranged as an interface of the sensor unit housing, i.e., in or on the sensor unit housing.

According to one design, the at least one signal transmitter of the main electronic path and/or the safety electronic path is a signal transformer, a digital isolator or an optical coupler or has at least one signal transformer, a digital isolator and/or an optical coupler.

Galvanic isolation can be achieved, for example, by comparatively small transmitters or transformers as signal transmitters, which can be arranged before the inputs and outputs of the sensor and on printed circuit boards. As a result, a comparatively inexpensive technology is used, which relates to the analog interfaces to the sensor unit. However, with this variant, the space required on the circuit board and in terms of height must be taken into account, as the transmitter or transformer must be designed correspondingly larger as the input voltage increases. Optical couplers can be used for this purpose, as well as for the subsequent digital signal transmission.

Alternatively or additionally, the galvanic isolation can also be carried out by means of digital interfaces. Since today's sensors often require further digital signal processing and transmit the required measured variables to the system via digital interfaces, digital isolators can be used at this system boundary. These digital isolators can be in the form of individual electronic components in the form of an integrated circuit and allow secure isolation of signal lines and supply lines, as well as communication and data interfaces, to meet the higher HV/ISO strength requirements. As mentioned above, however, an appropriately configured optical coupler can also be used as a digital isolator.

According to one design, at least one sensor unit is a resolver or has at least one resolver.

A resolver is a rotational angle sensor, which, similar to an electric motor, has a rotor and a stator. The rotor of the resolver can be made of a magnetically conductive material and form the magnetic return path for the magnetic field generated by the stator. Considering the winding in the stator of the resolver, two different areas can be distinguished. The first area corresponds to a rotary transformer, wherein the winding is arranged concentrically around the rotor. In the second area, the winding structure corresponds to the construction of a motor winding with two phases, but these are not connected to each other. The two winding areas are spatially separated from each other and magnetically coupled only by the rotor and the stator return path. For example, the excitation winding of the resolver is excited with a sinusoidal or rectangular high-frequency voltage, typically in the range of 2 kHz to 10 kHz. The alternating magnetic field is transferred by the rotor exclusively to the measuring windings and modulated in its amplitude. The voltages in the measuring windings can be used as evaluation variables. The output signals are then a sine oscillation and a cosine oscillation. Since the magnetic excitation of the rotor takes place with an alternating voltage of constant amplitude, it induces a voltage in the measuring windings with an amplitude that is independent of the revolution rate of the shaft of the brake drive. The amplitudes of the voltages in the measuring windings thus depend only on the rotor angle.

Due to the design of the resolver, which does not use any mechanical components with wear behavior, such as ball bearings, or electronic components, such as microprocessors, semiconductors or capacitors with solid electrolyte, the resolver itself offers a very high level of reliability.

In particular, the main electronic path and/or the safety electronic path has at least one resolver to digital converter which is specifically designed to magnetically excite a rotor of the resolver, optionally with a constant amplitude alternating voltage, and to receive sine and cosine signals of a stator of the resolver.

By using at least one resolver to digital converter, the resolver can be operated as a sensor unit in a simple way. The resolver to digital converter can be used both for the actuation of the resolver and for the measurement data evaluation. A digital interface of the resolver to digital converter, such as an SPI interface, can be used to transmit information about the measured quantities from the resolver to digital converter to a higher-level system, such as a microcontroller or an FPGA (Field Programmable Gate Array).

In particular, between the resolver to digital converter in the main electronic path and/or in the safety electronic path and the resolver, at least one excitation signal switch is arranged for the disconnection and connection of the resolver to digital converter and the resolver with respect to an excitation signal path in the main electronic path and/or safety electronic path, at least one sine signal switch for the disconnection and connection of the resolver to digital converter and the resolver with respect to a sine signal path is located in the main electronic path and/or the safety electronic path and/or at least one cosine signal switch for the disconnection and connection of the resolver to digital converter and the resolver with respect to a cosine signal path is arranged in the main electronic path and/or the safety electronic path.

The transmission of the excitation signals, sine signals and/or cosine signals can thus be switched between the resolver to digital converter in the main electronic path and/or in the safety electronic path and the resolver via the respective excitation signal switch, sine signal switch or cosine signal switch. The respective disconnection and connection can refer to a fault that triggers a switch from a main electronic path to a safety electronic path. Alternatively or additionally, a disconnection and connection can also be provided in the event of a detected overvoltage, so that overvoltage protection is realized.

According to a development, the at least one resolver to digital converter and/or a signal processing unit is or are designed to determine a rotational angle position of the resolver from the sine and cosine signals of the stator of the resolver, in particular taking into account a number of pole pairs of the resolver.

The evaluation of the resolver signals, i.e., the sine and cosine signals, is carried out, for example, by the formation of the arc tangent, which allows the electrical rotational angle position to be output. By including the number of pole pairs of the resolver, the output as a mechanical rotational angle position is also possible. Furthermore, a diagnosis of the resolver is possible by using the two output signals and the application of trigonometric calculations.

According to one design, the at least one resolver to digital converter is arranged in the main electronic path and/or in the safety electronic path in which the section of the main electronic path or section of the safety electronic path close to the sensor unit is arranged.

The at least one resolver to digital converter in the main electronic path and/or in the safety electronic path can thus be equally protected by the signal transmitter for galvanic isolation or can be galvanically isolated from the section of the main electronic path or the section of the safety electronic path which is remote from the sensor unit.

According to one design, the rotational angle detection system has at least one sensor unit and a safety path sensor unit as a further sensor unit, wherein the at least one safety electronic path can be operatively connected to the safety sensor unit.

For example, with regard to redundancy or for the detection of different sensor signals, not only can the at least one sensor unit be connected to the main electronic path and the safety electronic path as individual paths, but the safety electronic path can alternatively or additionally be operatively connected to another sensor unit that is different from the at least one sensor unit.

In particular, the sensor unit and the safety path sensor unit have a mutually different measurement principle or a mutually different measurement configuration.

The different measurement principle or the different measurement configuration can refer to the determination of the same measurement variable, i.e., the rotational angle. Alternatively or in addition, however, this can also be used to determine a further measurement variable, which supports a determination of the rotational angle or specifies the rotational angle in more detail or can also be independent of this. With regard to different measurement principles for determining a measurement variable, in this case the rotational angle, the sensor unit can be the resolver described above, while the other sensor unit is a Hall sensor. As an example of a different measurement configuration, the sensor unit and the other sensor unit can both be in the form of resolvers, but depending on the operating mode of the rotary brake drive, they can be actuated with different excitation signals.

According to one design, the rotational angle detection system has at least one signal processing unit in the main electronic path in the section of the main electronic path which is remote from the sensor unit and at least one signal processing unit in the safety electronic path in the section of the safety electronic path which is facing away from the sensor unit.

The at least one signal processing unit in the main electronic path and the safety electronic path is thus galvanically isolated from the at least one sensor unit by the signal transmitter. The possibility of corresponding signal processing by means of the main electronic path and the safety electronic path also allows for the redundant signal processing already mentioned.

According to one design, the rotational angle detection system has at least one signal processing unit and at least one other signal processing unit in the main electronic path in the section of the main electronic path which is remote from the sensor unit, wherein the at least one signal processing unit and the at least one other signal processing unit are connected in parallel.

Here, too, the at least one signal processing unit and the at least one other signal processing unit are galvanically isolated from the at least one sensor unit by the signal transmitter. The same sensor signal can be transmitted to both signal processing units via the main electronic path. The signal processing of the sensor signal can in turn be carried out redundantly by means of the parallel circuit.

According to a further aspect, disclosed embodiments relate to a braking system for a rail vehicle that has at least one brake actuator for applying a braking force, at least one rotary brake drive for actuating the brake actuator, and at least one rotational angle detection system described above.

The features described in the description above and below of the rotational angle detection system relate equally to advantageous developments of the brake system according to the disclosed embodiments and vice versa.

According to a further aspect, the disclosed embodiments relate to a rail vehicle with at least one rotational angle detection system described above and/or a braking system described above, wherein at least the sensor unit is arranged in a bogie of the rail vehicle.

The features described in the description above and below of the rotational angle detection system relate equally to advantageous developments of the rail vehicle according to the disclosed embodiments and vice versa.

The disclosed embodiments described above and below are not to be regarded as limiting to the subject matter of the invention. Rather, further objects according to the disclosed embodiments can be obtained by adding, omitting or exchanging individual features.

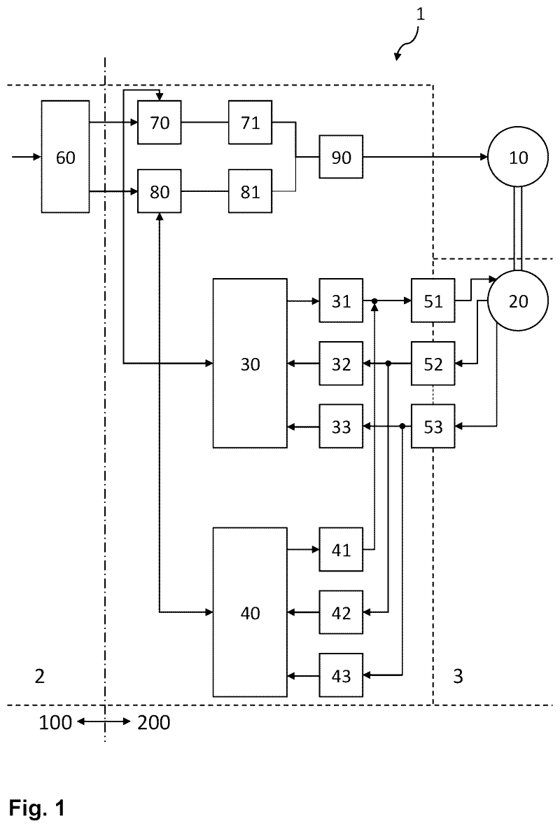

FIG. 1 shows a schematic representation of a rotational angle detection system 1 for a rail vehicle according to an exemplary first embodiment. The rotational angle detection system 1 has a resolver 20 as an exemplary sensor unit, which can transmit sensor signals corresponding to a rotational angle of a motor 10 as an exemplary rotary brake drive to a main electronic path described later and a safety electronic path also described later. The motor 10 is controlled by a motor drive controller 90, which transmits signals of a power supply 60 to the motor 10, taking into account a signal processing unit 70 related to the main electronic path as well as a signal processing unit 80 related to the safety electronic path. As shown here, the power supply is arranged in a train 100 as a higher level system unit of a rail vehicle, while the other components shown can be assigned to a brake actuator 200, which is provided in a bogie in the embodiment shown. The respective connections between the signal processing unit 70 and the signal processing unit 80 to the motor drive controller 90 can be disconnected and reconnected by means of respective signal output switches 71, 81.

The main electronic path connects the resolver 20 to the signal processing unit 70, which can be assigned to the main electronic path. To actuate the resolver 20, a resolver to digital converter 30, which in turn transmits an excitation signal to the resolver 20 via the main electronic path according to the control, is actuated by the signal processing unit 70 via the main electronic path. The connection between the resolver to digital converter 30 and the resolver 20 can be disconnected and reconnected by an excitation signal switch 31 in the main electronic path. In response to the excitation signal in conjunction with the rotational angle of the motor 10, the resolver 20 transmits sine signals and cosine signals via separate signal paths in the main electronic path to the resolver to digital converter 30, which transmits corresponding signals to the signal processing unit 70. The respective signal connections between the resolver to digital converter 30 and the resolver 20 can be equally disconnected and reconnected by a sine signal switch 32 and a cosine signal switch 33 in the main electronic path.

The safety electronic path is configured similarly to the main electronic path, and here it takes over the function of a safety electronic path which is redundant to the main electronic path. Accordingly, the safety electronic path connects the resolver 20 to the signal processing unit 80, which can be assigned to the safety electronic path. To actuate the resolver 20, a resolver to digital converter 40 is actuated by the signal processing unit 80 via the safety electronic path, and in turn transmits an excitation signal to the resolver 20 via the safety electronic path according to the actuation. The connection between the resolver to digital converter 40 and the resolver 20 can be disconnected and reconnected by an excitation signal switch 41 in the main electronic path. In response to the excitation signal in conjunction with the rotational angle of the motor 10, the resolver 20 transmits sine signals and cosine signals via separate signal paths in the safety electronic path to the resolver to digital converter 40, which transmits corresponding signals to the signal processing unit 80. The respective signal connections between the resolver to digital converter 40 and the resolver 20 can be equally disconnected and reconnected by a sine signal switch 42 and a cosine signal switch 43 in the safety electronic path.

For the galvanic isolation of the resolver 20 from the other components mentioned above in the main electronic path and in the safety electronic path, an excitation signal transformer 51 is arranged in the signal path for the excitation signal between the excitation signal switch 31 or 41 and the resolver 20, a sine signal transformer 52 is arranged in the signal path for the sine signal between the sine signal switch 32 or 42 and the resolver 20, and a cosine signal transformer 53 is arranged in the signal path for the cosine signal between the cosine signal switch 33 or 43 and the resolver 20. The respective transformers 51, 52, 53 divide the corresponding signal paths into a corresponding section of the signal path which is close to the resolver 20 and a corresponding section of the signal path which is remote from the resolver 20. The resolver 20 is arranged here in a sensor unit housing 3. The respective signal transformers 51, 52, 53 for galvanic isolation in the design shown are in the form of housing interfaces of the sensor unit housing 3 or are suitably integrated into an interface area of the sensor unit housing 3. According to this, the section of the signal path which is close to the resolver 20 is arranged in the sensor unit housing 3, while the section of the signal path which is remote from the resolver 20 is assigned to an area of a battery potential 2.

Due to the configuration described above with the signal transformers 51, 52, 53 connected into the signal supply lines to the resolver 20, a standard resolver with a metallic casing can still be used, which can offer advantages in terms of cost, durability and availability. The signal transformers 51, 52, 53 can also be available comparatively cheaply and can only have slightly higher failure rates, for example +30 FIT (“Failure in Time”). In order to reduce the space requirements of the signal transformers 51, 52, 53, a resolution and/or the reduction of the supply voltage for the resolver 20, for example from 7 Vrms to 1 Vrms, can be considered if necessary, for example, based on the maximum available installation space.

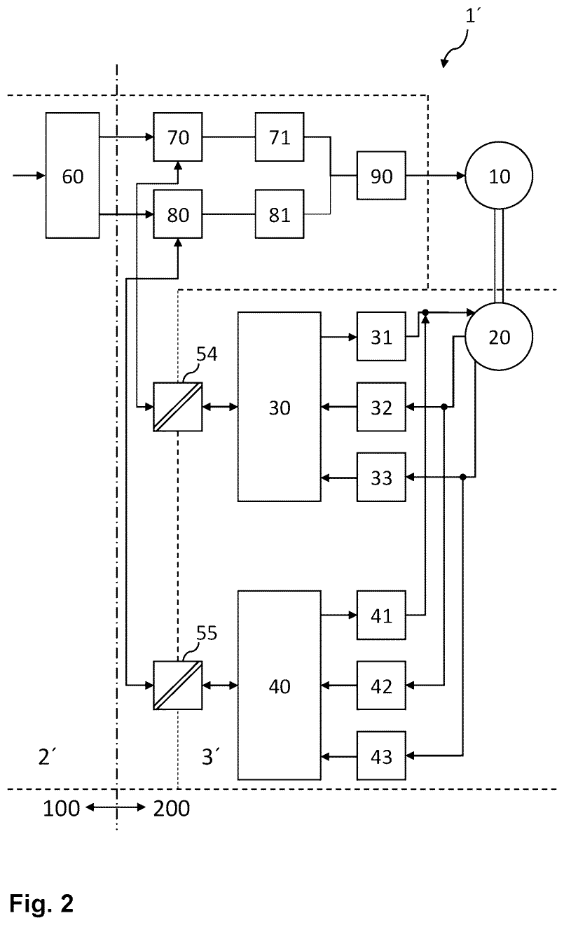

FIG. 2 shows a schematic representation of a rotational angle detection system 1′ for a rail vehicle according to an exemplary second embodiment. The rotary angle sensing system 1′ of the second embodiment differs from the rotational angle sensing system 1 of the first embodiment in that the rotational angle sensing system 1 provides galvanic isolation between the signal processing unit 70 and the resolver to digital converter 30 in the main electronic path and galvanic isolation between the signal processing unit 80 and the resolver to digital converter 40 in the safety electronic path instead of the galvanic isolation directly adjacent to the resolver 20 provided by the signal transformers 51, 52, 53. The resolver 20 as well as the resolver to digital converter 30 and the excitation signal switch 31, the sine signal switch 32 and the cosine signal switch 33 of the main electronic path are arranged in a sensor unit housing 3 for this purpose. For the galvanic isolation of the resolver 20 as well as the resolver to digital converter 30 and the excitation signal switch 31, the sine signal switch 32 and the cosine signal switch 33 from the signal processing unit 70, a digital isolator 54 is provided in the main electronic path, which divides the main electronic path into a section of the main electronic path which is close to the resolver 20 and a section of the main electronic path which is remote from the resolver 20. The digital isolator 54 is configured in such a way that it provides galvanic isolation between the section of the main electronic path which is close to the resolver 20 with the resolver to digital converter 30 and the excitation signal switch 31, the sine signal switch 32 and the cosine signal switch 33 and the section of the main electronic path which is remote from the resolver 20 with the signal processing unit 70. The digital isolator 54 in the design shown is in the form of a housing interface of the sensor unit housing 3 or is suitably integrated into an interface area of the sensor unit housing 3. According to this, the section of the main electronic path which is close to the resolver 20 is arranged in the sensor unit housing 3, while the section of the main electronic path which is remote from the resolver 20 is assigned to an area of a battery potential 2′.

For the galvanic isolation of the resolver 20 as well as the resolver to digital converter 40 and the excitation signal switch 41, the sine signal switch 42 and the cosine signal switch 43 from the signal processing unit 80, a digital isolator 55 is provided in the safety electronic path similarly to in the main electronic path, which divides the safety electronic path into a section of the safety electronic path which is close to the resolver 20 and a section of the safety electronic path which is remote from the resolver 20. The digital isolator 55 is configured to provide galvanic isolation between the section of the safety electronic path which is close to the resolver 20 with the resolver to digital converter 40 and the excitation signal switch 41, the sine signal switch 42 and the cosine signal switch 43 and the section of the safety electronic path which is remote from the resolver 20 with the signal processing unit 80. The digital isolator 55 in the design shown is in the form of a housing interface of the sensor unit housing 3 or is suitably integrated into an interface area of the sensor unit housing 3. According to this, the section of the safety electronic path which is close to the resolver 20 is arranged in the sensor unit housing 3, while the section of the safety electronic path which is remote from the resolver 20 is assigned to an area of a battery potential 2′.

The digital isolators 54, 55 here are thus connected upstream of the respective resolver to digital converters 30, 40 of the respective signal processing units 70, 80 in the direction of the resolver 20 in order to enable galvanic isolation of the supply voltage and the digital I/O interfaces. In the case of a redundant design with a main electronic path and a safety electronic path, a digital isolator 54, 55 must therefore be provided for each signal path.

In all other respects, the explanations of the first embodiment can be correspondingly transferred to the second embodiment.

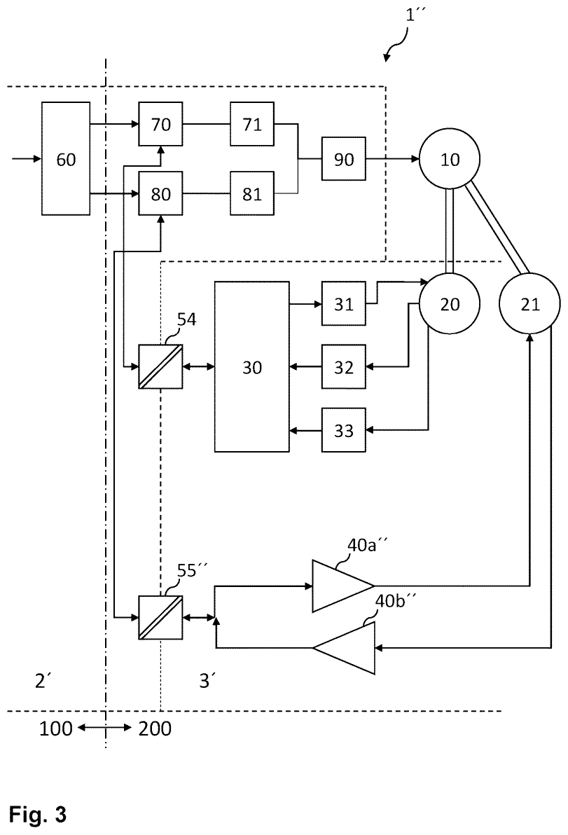

FIG. 3 shows a schematic representation of a rotational angle detection system 1″ for a rail vehicle according to an exemplary third embodiment. The rotational angle detection system 1″ of the third embodiment differs from the rotational angle detection system 1 of the second embodiment in that the rotational angle detection system 1″ has a safety path sensor unit 21 as an additional sensor unit in addition to the resolver 20. The main electronic path of the rotational angle detection system 1″ does not differ in its functional principle and configuration from the main electronic path of the rotational angle detection system 1′, so that reference is made to the above remarks on FIG. 2 for this.

The distinction between the embodiment in relation to the safety path sensor unit 21 in conjunction with the safety electronic path refers in particular to the fact that a separate complete signal path is formed which includes the safety path sensor unit 21. The safety path sensor unit 21 in the exemplary design is based on a different measuring principle and is in the form of a Hall sensor here. Accordingly, there are also different signal lines of the safety electronic path for the actuation and signal feedback to the resolver 20. This is represented by a signal converter 40a″ for an actuation signal and by a signal converter 40b ″ for sensor signal feedback in the respective signal paths of the safety electronic path. Accordingly, the digital isolator 55″ of the safety electronic path of the rotational angle detection system 1″ may also be designed differently than the digital isolator 55 of the safety electronic path of the rotational angle detection system 1″.

In all other respects, the explanations of the second embodiment are correspondingly transferable to the third embodiment.

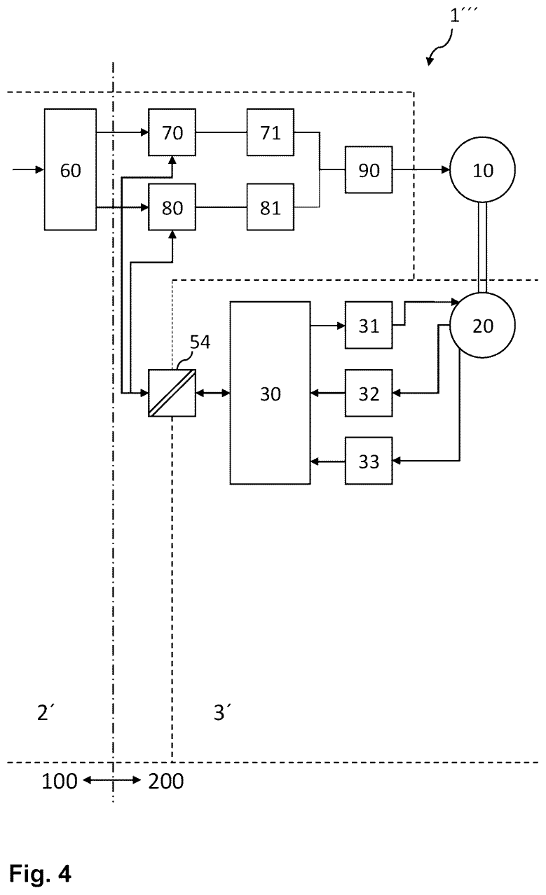

FIG. 4 shows a schematic representation of a rotational angle detection system 1″ for a rail vehicle according to an exemplary fourth embodiment. The rotational angle detection system 1″ of the fourth embodiment differs from the rotational angle detection system 1′of the second embodiment in that the rotational angle detection system 1″ does not have a safety electronic path with corresponding components. At least partial redundancy is provided here with regard to a redundant design of the signal processing units 70, 80, which are connected in parallel via the digital isolator 54 to the resolver to digital converter 30. According to this, the rotational angle detection system 1″ has two identical interface connections to the two signal processing units 70, 80, which are also used for actuation. This means that more standard components can be used. With failure rates of digital isolators of approximately 10 FIT, for example, this does not necessarily increase the probability of failure of the entire system.

In all other respects, the explanations of the second embodiment can be correspondingly transferred to the fourth embodiment.

### LIST OF REFERENCE SIGNS

1, 1′,1″, 1″′ Rotational angle detection system
2, 2′Battery potential
3,3′Sensor unit housing
10 Motor (brake drive)
20 Resolver (sensor unit)
21 Safety path sensor unit (sensor unit)
30 Resolver to digital converter (main electronic path)
31 Excitation signal switch (main electronic path)
32 Sine signal switch (main electronic path)
33 Cosine signal switch (main electronic path)
40 Resolver to digital converter (safety electronic path)
40a″ Signal converter (safety electronic path)
40b″ Signal converter (safety electronic path)
41 Excitation signal switch (safety electronic path)
42 Sine signal switch (safety electronic path)
43 Cosine signal switch (safety electronic path)
51 Excitation signal transformer
52 Sine signal transformer
53 Cosine signal transformer
54 Digital isolator (main electronic path)
55, 55″ Digital isolator (safety electronic path)
60 Power supply
70 Signal processing unit (main electronic path)
71 Signal output switch (main electronic path)
80 Signal processing unit (safety electronic path)
81 Signal output switch (safety electronic path)
90 Motor drive control
100 Train
200 Brake actuator

1. A rotational angle detection system for a rotational angle detection of a rotary brake drive for a rail vehicle, the rotational angle detection system comprising:
at least one sensor unit configured to detect a rotational angle, and operatively connectable to the rotary brake drive; and
at least one main electronic path configured to transmit control signals and/or sensor signals, wherein the at least one main electronic path is operatively connectable to the at least one sensor unit,
wherein the at least one main electronic path has at least one signal transmitter which divides the main electronic path into a section of the main electronic path which is close to the signal transmitter when viewed from the sensor unit and a section of the main electronic path which is remote from the signal transmitter when viewed from the sensor unit and
wherein the at least one signal transmitter is configured to galvanically isolate the at least one sensor unit from the section of the main electronic path which is remote from the sensor unit.

2. The rotational angle detection system claim 1, wherein the rotational angle detection system further comprises:
at least one safety electronic path configured to transmit control signals and/or sensor signals, wherein the at least one safety electronic path is operatively connectable to the at least one sensor unit,
wherein the at least one safety electronic path has at least one signal transmitter, which divides the safety electronic path into a section of the safety electronic path which is close to the signal transmitter when viewed from the sensor unit and a section of the safety electronic path which is remote from the signal transmitter when viewed from the sensor unit and
wherein the at least one signal transmitter is configured to galvanically isolate the at least one sensor unit from the section of the safety electronic path which is remote from the sensor unit.

3. The rotational angle detection system of claim 1, wherein the at least one sensor unit is arranged in a sensor unit housing and the at least one signal transmitter of the main electronic path forms a signal input and/or signal output of the main electronic path into and/or out of the sensor unit housing.

4. The rotational angle detection system of claim 1, wherein the at least one signal transmitter of the main electronic path is a signal transformer, a digital isolator or an optical coupler or at least has a signal transformer, a digital isolator and/or an optical coupler.

5. The rotational angle detection system of claim 1, wherein the at least one sensor unit is a resolver or has at least one resolver.

6. The rotational angle detection system of claim 5, wherein the main electronic path has at least one resolver to digital converter configured to magnetically excite a rotor of the resolver with an alternating voltage of constant amplitude, and to receive sine and cosine signals of a stator of the resolver.

7. The rotational angle detection system of claim 6, wherein between the resolver to digital converter in the main electronic path and the resolver at least one excitation signal switch is arranged for disconnecting and connecting the resolver to digital converter and the resolver with respect to an excitation signal path in the main electronic path, at least one sine signal switch for the purpose of disconnecting and connecting the resolver to digital converter and the resolver with respect to a sine signal path in the main electronic path and/or at least one cosine signal switch for disconnecting and connecting the resolver to digital converter and the resolver with respect to a cosine signal path in the main electronic path.

8. The rotational angle detection system of claim 7, wherein the at least one resolver to digital converter and/or one signal processing unit is/are designed to determine a rotational angle position of the resolver from the sine and cosine signals of the stator of the resolver taking into account a number of pole pairs of the resolver.

9. The rotational angle detection system of claim 1, wherein the at least one resolver to digital converter is located in the main electronic path in the section of the main electronic path close to the sensor unit.

10. The rotational angle detection system of claim 2, wherein the rotational angle detection system comprises at least one sensor unit and a safety path sensor unit as a further sensor unit, wherein the at least one safety electronic path is operatively connectable to the safety sensor unit.

11. The rotational angle detection system of claim 10, wherein the sensor unit and the safety path sensor unit have a mutually different measuring principle or a mutually different measuring configuration.

12. The rotational angle detection system of claim 1, wherein the rotational angle sensing system has at least one signal processing unit in the section of the main electronic path remote from the sensor unit.

13. The rotational angle detection system of claim 1, wherein the rotational angle detection system comprises at least one signal processing unit and at least one other signal processing unit in the main electronic path in the section of the main electronic path which is remote from the sensor unit, and wherein the at least one signal processing unit and the at least one other signal processing unit are connected in parallel.

14. A braking system for a rail vehicle, comprising:
at least one brake actuator for applying a braking force,
at least one rotary brake drive for actuating the brake actuator, and
at least one rotational angle detection system as claimed in claim 1.

15. A rail vehicle having at least one rotational angle detection system of claim 1, wherein at least the sensor unit is arranged in a bogie of the rail vehicle.

16. The rotational angle detection system of claim 2, wherein the at least one sensor unit is arranged in a sensor unit housing and the at least one signal transmitter of the safety electronic path forms a signal input and/or signal output of the safety electronic path into and/or out of the sensor unit housing.

17. The rotational angle detection system of claim 2, wherein the at least one signal transmitter of the safety electronic path is a signal transformer, a digital isolator or an optical coupler or at least has a signal transformer, a digital isolator and/or an optical coupler.

18. The rotational angle detection system of claim 5, wherein the safety electronic path has at least one resolver to digital converter configured to magnetically excite a rotor of the resolver with an alternating voltage of constant amplitude, and to receive sine and cosine signals of a stator of the resolver.

19. The rotational angle detection system of claim 18, wherein between the resolver to digital converter in the safety electronic path and the resolver at least one excitation signal switch is arranged for disconnecting and connecting the resolver to digital converter and the resolver with respect to an excitation signal path in the safety electronic path, at least one sine signal switch for the purpose of disconnecting and connecting the resolver to digital converter and the resolver with respect to a sine signal path in the safety electronic path and/or at least one cosine signal switch for disconnecting and connecting the resolver to digital converter and the resolver with respect to a cosine signal path in the main electronic path and/or safety electronic path.

20. The rotational angle detection system of claim 19, wherein the at least one resolver to digital converter and/or one signal processing unit is/are designed to determine a rotational angle position of the resolver from the sine and cosine signals of the stator of the resolver taking into account a number of pole pairs of the resolver.

21. The rotational angle detection system of claim 2, wherein the at least one resolver to digital converter is located in the safety electronic path in the section of the section of the safety electronic path close to the sensor unit.

22. The rotational angle detection system of claim 2, wherein the rotational angle sensing system has at least one signal processing unit in the section of the safety electronic path remote from the sensor unit.

23. The rotational angle detection system of claim 2, wherein the rotational angle detection system comprises at least one signal processing unit and at least one other signal processing unit in the main electronic path in the section of the main electronic path which is remote from the sensor unit, and wherein the at least one signal processing unit and the at least one other signal processing unit are connected in parallel.

24. A braking system for a rail vehicle, comprising:
at least one brake actuator for applying a braking force,
at least one rotary brake drive for actuating the brake actuator, and
at least one rotational angle detection system as claimed in claim 2.

25. A rail vehicle having at least one rotational angle detection system of claim 2, wherein at least the sensor unit is arranged in a bogie of the rail vehicle.
